(19) United States
(12) Patent Application Publication
(10) Pub. No.: US 2024/0304013 A1
(43) Pub. Date: Sep. 12, 2024

(54) TEXT RECOGNITION METHOD AND DEVICE, AND ELECTRONIC DEVICE

(71) Applicant: Lenovo (Beijing) Limited, Beijing (CN)

(72) Inventors: Jiaming TAO, Beijing (CN); Yan XIANG, Beijing (CN)

(21) Appl. No.: 18/600,621

(22) Filed: Mar. 8, 2024

(30) Foreign Application Priority Data
Mar. 10, 2023 (CN) 202310259454.X

(51) Int. Cl. G06V 30/14; G06V 30/262; G06V 30/416

(52) U.S. Cl. CPC G06V 30/1456; G06V 30/262; G06V 30/416

(57) ABSTRACT

A text recognition method includes: obtaining a text image and contextual information of an interactive environment in which the electronic device is currently located, the text image being obtained by collecting images of a to-be-recognized text; obtaining a text filtering condition for the to-be-recognized text based on the contextual information; performing text recognition on the text image to obtain a corresponding text recognition result; obtaining the to-be-recognized text included in the text image based on the text filtering condition and the text recognition result; and outputting the to-be-recognized text.

### CROSS-REFERENCES TO RELATED APPLICATION

This application claims priority to Chinese Patent Application No. 202310259454X filed on Mar. 10, 2023, the entire content of which is incorporated herein by reference.

### FIELD OF TECHNOLOGY

The present disclosure relates to the field of artificial intelligence technology and, more specifically, to a text recognition method and device, and an electronic device.

### BACKGROUND

With the rapid development of artificial intelligence technology, optical character recognition (OCR) text recognition technology has been widely used in various electronic devices. When a user needs to input text content on an object, the camera of the electronic device can be initiated to collect the image of the text area, and by performing OCR recognition on the image of the text area, input text content can be directly obtained, without the user having to manually enter the text content, which is very convenient.

### SUMMARY

One aspect of this disclosure provides a text recognition method. The method includes obtaining a text image and contextual information of an interactive environment in which the electronic device is currently located, the text image being obtained by collecting images of a to-be-recognized text; obtaining a text filtering condition for the to-be-recognized text based on the contextual information; performing text recognition on the text image to obtain a corresponding text recognition result; obtaining the to-be-recognized text included in the text image based on the text filtering condition and the text recognition result; and outputting the to-be-recognized text.

Another aspect of the present disclosure provides a text recognition device. The device includes a text image acquisition module, a contextual information acquisition module, a text filtering condition acquisition module, a text recognition model, a to-be-recognized text acquisition module, and an output module. The text image acquisition module is configured to obtain a text image, the text image being obtained by collecting images of a to-be-recognized text. The contextual information acquisition module is configured to obtain the contextual information of a current interactive environment of an electronic device. The text filtering condition acquisition module is configured to obtain a text filtering condition for the to-be-recognized text based on contextual information. The text recognition model is used to perform text recognition on the text image to obtain a corresponding text recognition result. The to-be-recognized text acquisition module is configured to perform text recognition on the text image based on the text filtering condition and the text recognition result to obtain the to-be-recognized text included in the text image. The output module is configured to output the to-be-recognized text.

Another aspect of the present disclosure provides an electronic device. The electronic device includes a communication device, an output device, a storage device, and a processing device. The storage device stores a program for implementing a text recognition method. The processing device is configured to load and execute the program stored in the storage device to implement the text recognition method. The text recognition method includes obtaining a text image and contextual information of an interactive environment in which the electronic device is currently located, the text image being obtained by collecting images of a to-be-recognized text; obtaining a text filtering condition for the to-be-recognized text based on the contextual information; performing text recognition on the text image to obtain a corresponding text recognition result; obtaining the to-be-recognized text included in the text image based on the text filtering condition and the text recognition result; and outputting the to-be-recognized text.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a schematic diagram of a text recognition method.

FIG. 2 is another schematic diagram of the text recognition method.

FIG. 3 is a flowchart of the text recognition method according to an embodiment of the present disclosure.

FIG. 4 is a flowchart of the text recognition method according to an embodiment of the present disclosure.

FIG. 5 is a flowchart of the text recognition method according to an embodiment of the present disclosure.

FIG. 6 is a schematic diagram of a scenario of the text recognition method according to an embodiment of the present disclosure.

FIG. 7 is a schematic diagram of another scenario of the text recognition method according to an embodiment of the present disclosure.

FIG. 8 is a flowchart of the text recognition method according to an embodiment of the present disclosure.

FIG. 9 is a schematic diagram of a scenario for outputting to-be-recognized text in the text recognition method according to an embodiment of the present disclosure.

FIG. 10 is a schematic structural diagram of a text recognition device according to an embodiment of the present disclosure.

FIG. 11 is a hardware structural diagram of an electronic device suitable for the text recognition method according to an embodiment of the present disclosure.

FIG. 12 is a hardware structural diagram of the electronic device suitable for the text recognition method according to an embodiment of the present disclosure.

### DETAILED DESCRIPTION

Compared to the conventional text recognition methods described above, the text recognition method in the present disclosure can be used to further simplify the user's input processes in the text recognition process, reduce the user's workload, and improve the text recognition efficiency.

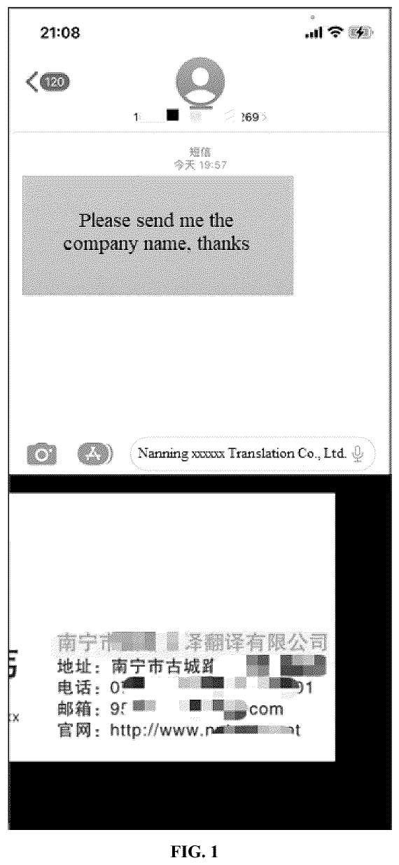

In various implementations, such as an implementation of a text recognition method shown in FIG. 1, the user needs to constantly adjust the positional relationship between the camera and the text area on the object such that the to-be-input text is at the center of the latest capture text area image (such as the image displayed of the preview interface) in order to accurately obtain the required to-be-recognized text. This process is cumbersome and has poor user experience.

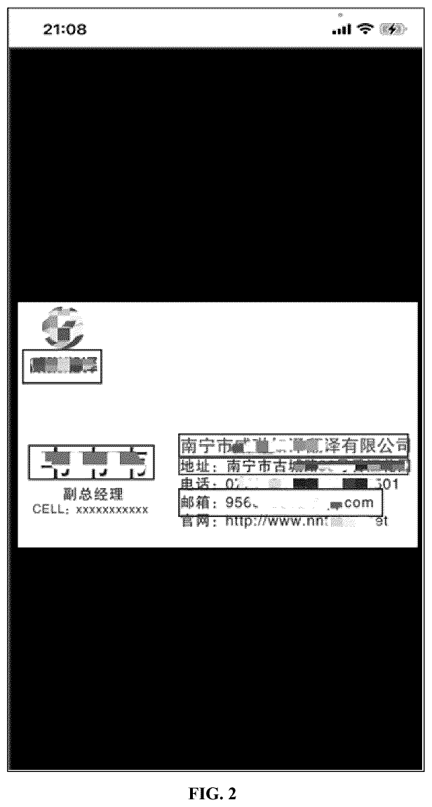

To reduce the user workload, a text input method shown in FIG. 2 can be used. In this case, after the electronic device recognizes all the text included in the text area image, the user selects the text that needs to be input. Although the text area image does not need to be updated multiple times, the user still needs to spend a certain amount of time to select the required text from all the recognized texts, which reduces the efficiency of text recognition.

In embodiments of the present disclosure, text filtering conditions for the to-be-recognized text that need to be input can be obtained based on the contextual information of the interactive environment (such as in a conversation or information search environment) in which the electronic device is currently located. Accordingly, the position of the to-be-recognized text in the text image is no longer required, and text recognition can be performed directly on the text image. After each text included in the text image is obtained, the to-be-recognized text that meets the text filtering conditions can be automatically determined. The user does not need to manually select the to-be-recognized text, thereby ensuring the efficiency and accuracy of text recognition.

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

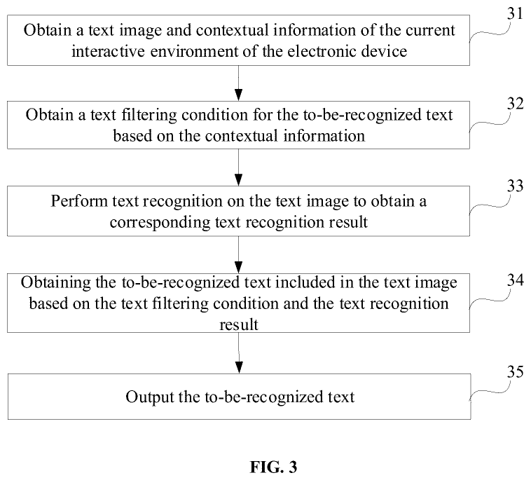

FIG. 3 is a flowchart of the text recognition method according to an embodiment of the present disclosure. The method can be applied to electronic devices such as smartphones, tablets, laptops, wearable devices (such as smart watches, smart glasses, etc.), smart robots and other terminal devices. For the composition and structure of the electronic device, reference can be made to the description of the corresponding parts of the following embodiments. This embodiment describes the implementation process of the text recognition method executed by the electronic device. The text recognition method will be described in detail below.

31, obtaining a text image and contextual information of the current interactive environment of the electronic device.

In some embodiments, electronic devices can be in any interactive environment, such as the conversation environment as shown in FIG. 1, or other information search/text entry environments, etc. If there is a need to enter text on an object (i.e., to-be-recognized text) in the text input box in this interactive environment, in order to improve the efficiency of text recognition and reduce the workload and error rate of manual text input, image capture can be performed on the to-be-recognized text and a text image containing the to-be-recognized text can be obtained. The method of capturing the text image is not limited to the embodiments of the present disclosure.

Subsequently, in view of the relevant description of the technical solutions of the present disclosure, in order to predict the to-be-recognized text that the user needs to input, contextual information (such as historical conversation messages in the conversation environment, or input prompt information in the information search environment, etc.) of the current interactive environment of the electronic device (that is, the interactive environment where the to-be-recognized text needs to be obtained) can be obtained. The present disclosure does not limit the content of the contextual information in different interactive environments, which can be set based on actual needs.

In some embodiments, the contextual information may be recorded when the contextual information is generated or received by the electronic device. Accordingly, when text input is required, the recorded contextual information of the current interactive environment can be read. It should be understood that for interactive environments such as conversations, there may be a lot of associated contextual information. In this case, the contextual information recorded within a preset period of time (e.g., 1 minute, 5 minutes, 15 minutes, or 30 minutes, which is not limited in the embodiments of the present disclosure) from the current time can be obtained based on the current time of the electronic device. However, the method of obtaining the contextual information is not limited to the embodiments of the present disclosure.

32, obtaining a text filtering condition for the to-be-recognized text based on contextual information.

In some embodiments, since contextual information may contain or characterize the input requirements of the interactive environment visited by the user, with the development of artificial intelligence technology, in the present disclosure, the contextual information of the interactive environment may be analyzed to predict the text content that needs to be input in the interactive environment and generate the text filtering condition that can filter out the text content. In some embodiments, the text filtering condition may include content that can characterize or include the to-be-recognized text. The present disclosure does not limit the form and content of the text filtering condition.

For example, in the conversation environment as shown in FIG. 1, the obtained contextual information may include conversation messages such as “please send me the company name”. By analyzing this message, it can be seen that the other party of the conversation wants the local user to enter the company name, and the text filtering condition for identifying the company name can be obtained. For example, key information such as “company name” may be used to form a text filtering condition for the to-be-recognized text, or a text filtering condition containing or characterizing the key information may be generated based on a preset condition template. The present disclosure does not limit the method of generating the text filtering condition.

33, performing text recognition on the text image to obtain a corresponding text recognition result.

In some embodiments, a pre-trained text recognition model may be called to perform text recognition on the currently acquired text image, and each text included in the text image can be obtained, thereby forming the text recognition result of the text image. The present disclosure does not limit the method of image text recognition. In some embodiments, the text recognition model may be based on machine learning or deep learning algorithms, and may be obtained by training the model on sample text images, which will not be described in detail in the present disclosure.

34, obtaining the to-be-recognized text included in the text image based on the text filtering condition and the text recognition result.

In some embodiments, after the electronic device obtains each text included in the text image, the electronic device may filter each recognized text based on the text filtering condition for the to-be-recognized text, such as detecting whether each text meets the text filtering condition, and determining one or more texts that meet the text filtering condition as the to-be-recognized text. Continuing with the above example, the text belonging to the company name in the text image can be determined as the to-be-recognized text.

In some embodiments, after the electronic device obtains the text filtering condition for the to-be-recognized text, the electronic device may also directly perform text recognition based on the text filtering condition during the text recognition process of the currently obtained text image. That is, based on the text filtering condition, text recognition can be performed on the text image to obtain the to-be-recognized text that meets the text filtering condition. Accordingly, during the text recognition process, for any text, if words such as “address”, “phone” or “email” are recognized, it may indicate that this text is not a “company name” and does not meet the text filtering condition for filtering the to-be-recognized text for company names. Therefore, there is no need to identify the subsequent text of this text, thereby reducing the workload of text recognition and improving the efficiency of determining the to-be-recognized text.

In some embodiments, after determining the to-be-recognized text in the text image that meets the text filtering condition based on the method described above, the to-be-recognized text may be cached. For example, the to-be-recognized text can be copied, waiting for the subsequent paste input operation. However, the caching method is not limited to the text copy method.

35, outputting the to-be-recognized text.

In different interactive environments, the obtained to-be-recognized text may be output in different ways. In some embodiments, the obtained to-be-recognized text may be directly written into a text input box in the current interactive environment, and the to-be-recognized text may be displayed in the text input box.

In some embodiments, in order to highlight the to-be-recognized text in the text image, in the present disclosure, the display state of the to-be-recognized text may also be adjusted, such as changing the font color and/or shape and/or background color of the to-be-recognized text, etc. such that the user can directly see the content of the to-be-recognized text and determine whether the to-be-recognized text is the text that needs to be input. Of course, in order for the user to conveniently view the obtained to-be-recognized text, in the present disclosure, other methods may be used to output the to-be-recognized text. The present disclosure does not limit the method of outputting the to-be-recognized text, which can be set based on actual needs.

Consistent with the present disclosure, when there is a need to quickly and accurately identify the to-be-recognized text in a text image, the contextual information of the interactive environment of the electronic device can be obtained, based on the contextual information, the text filtering condition for the to-be-recognized text can be obtained such that text recognition can be performed on the text image. After obtaining the text recognition results, in combination of the text filtering condition, the to-be-recognized text included in the text image can be automatically and accurately obtained, without the user having to manually select the to-be-recognized text. In addition, when collecting text images, there is no need to pay attention to the position of the to-be-recognized text in the text image, which greatly reduces the time spent in the text image collection process and the to-be-recognized text screening process, thereby reducing user's workload and improving text recognition efficiency.

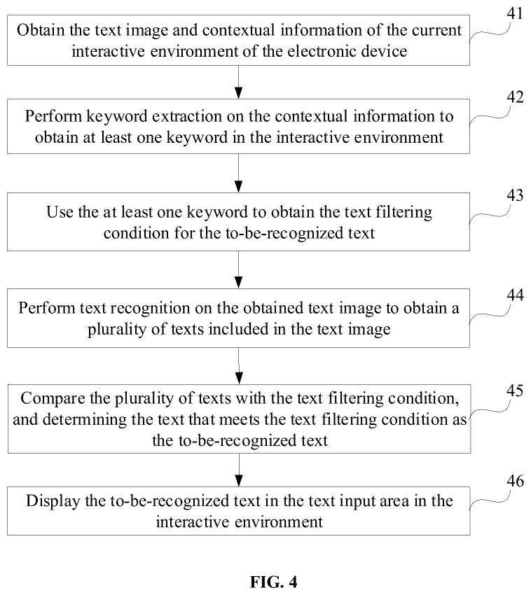

FIG. 4 is a flowchart of the text recognition method according to an embodiment of the present disclosure. This embodiment describes a refined implementation method of the text recognition method described above. The refined implementation method can still be applied to electronic devices. The method will be described in detail below.

41, obtaining the text image and contextual information of the current interactive environment of the electronic device.

For the implementation process of the process at 41, reference can be made to the relevant description of the corresponding parts of the foregoing embodiments, which will not be repeated here.

42, performing keyword extraction on contextual information to obtain at least one keyword in the interactive environment.

43, using the at least one keyword to obtain the text filtering condition for the to-be-recognized text.

For the implementation process of the method of obtaining the text filtering condition based on the contextual information of the interactive environment, in combination with the analysis of the corresponding parts above, keyword extraction may be performed on the contextual information based on artificial intelligence algorithms, such as semantic analysis of the contextual information to determine the keywords included in the contextual information. In addition, synonyms of the keywords may also be obtained and determined as keywords that represent the contextual information gist or key information that characterize the interactive environment. The present disclosure does not limit the method of extracting keywords from contextual information.

For example, the “company name” in the conversation message of “please send me your company name”, the “contact information” in the conversation message of “send me your contact information” or in the account and password information input environment of an application login interface, the prompt fields that need to be entered such as “account number” and “password” can be the extracted keywords. That is, in the present disclosure, in different interactive environments, the corresponding keywords in the company name, account number, password, contact information, address and phone number belonging to the contract information, etc. can be determined. However, the present disclosure is not limited to the keywords and the extraction methods listed here.

Subsequently, in the present disclosure, the at least one keyword obtained directly in the interactive environment may be determined as the text filtering condition of the to-be-recognized text. In some embodiments, a preset condition template of the text filtering condition may also be obtained. Based on the preset condition template, at least one keyword in the interactive environment can be processed to obtain the text filtering condition for the to-be-recognized text. In some embodiments, the preset condition template for determining statements such as “is xxxx (i.e., the to-be-detected text/statement) the same as xxxx (i.e., the obtained keywords, such as company name or contact information)?” may be built in advance.

Therefore, for different preset condition templates, the content of the generated text filtering condition may be different. The present disclosure does not limit the content of the preset condition template and the generation method of the text filtering condition, which can be set based on actual needs.

44, performing text recognition on the obtained text image to obtain a plurality of texts included in the text image.

45, comparing the plurality of texts with the text filtering condition, and determining the text that meets the text filtering condition as the to-be-recognized text.

Continuing with the above analysis. The present disclosure follows but is not limited to the method described above. After obtaining the text filtering condition of the to-be-recognized text in the current interactive environment, the text filtering condition may be transferred to a text recognition module, such as a pre-trained text recognition model, used to realize image text recognition. Accordingly, after performing text recognition on the currently obtained text image and obtaining each text included in the text image, each recognized text can be compared with the text filtering condition, and the to-be-recognized text I the text image that meets the text filtering condition can be automatically determined.

Therefore, regardless of the position of the to-be-recognized text in the text image, the to-be-recognized text can be automatically recognized in the plurality of texts included in the text image based on the text filtering condition. In addition, compared to the text recognition method shown in FIG. 2, the user does not need to review each text directly recognized from the text filtering condition, and manually filter out the required to-be-recognized text, which reduces user input operations and the time spent reviewing each text, especially when the text image contains many texts. In the embodiments of the present disclosure, the to-be-recognized text can be automatically screened based on the text filtering condition, which greatly improves the efficiency and accuracy of text recognition.

46, displaying the to-be-recognized text in the text input area in the interactive environment.

When the text input area in the current interactive environment is output in the display interface of the electronic device, such as the text input box in the conversation interface as shown in FIG. 1, or the input box in the information input interface, etc., after the electronic device automatically and accurately obtains the to-be-recognized text in the text image based on the method described above, the electronic device may directly cache the to-be-recognized text, write the to-be-recognized text into the text input area in the interactive environment, and display the to-be-recognized text in the text input area. However, the present disclosure is not limited to this implementation method of outputting the to-be-recognized text.

Consistent with the present disclosure, after text recognition is performed on any collected text image and each text included in the text image is determined, the required to-be-recognized text can be automatically filtered out from these texts based on the text filtering condition obtained based on the contextual information, and automatically written into the text input area in the current interactive environment for display. Accordingly, there is no need for the user to manually select the to-be-recognized text and write the to-be-recognized text into the text input area, which reduces the user's workload.

In addition, as analyzed above, in the present disclosure, the to-be-recognized text can be automatically filtered out from each text in the text image based on the text filtering condition for the to-be-recognized text, such as automatically searching for fields such as “name”, “phone” or “address”, and determining the text containing this field as the to-be-recognized text. Compared with the text recognition method shown in FIG. 1, in the embodiments of the present disclosure, there is no need to adjust parameters such as the shooting angle when collecting text images, and the to-be-recognized text can be at the center of the text image in the image preview interface, thereby saving the time spent adjusting the text images and improving text recognition efficiency and user experience.

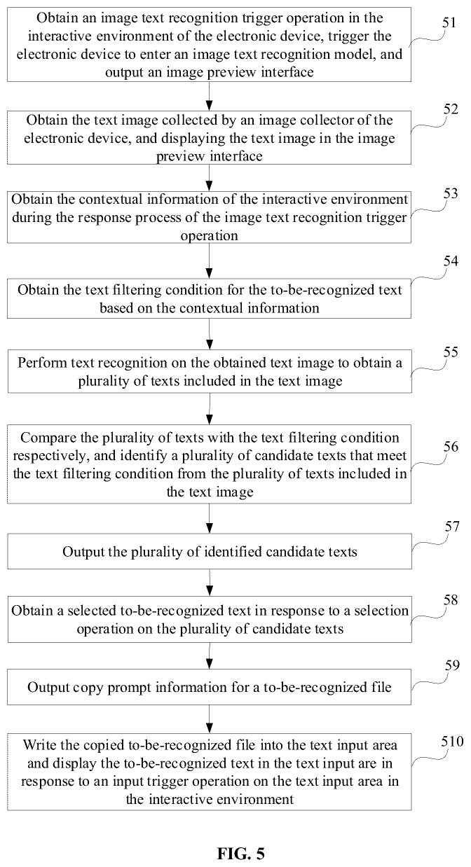

FIG. 5 is a flowchart of the text recognition method according to an embodiment of the present disclosure. This embodiment describes a refined implementation method of the text recognition method described above. The refined implementation method can still be applied to electronic devices. The method will be described in detail below.

51, obtaining an image text recognition trigger operation in the interactive environment of the electronic device, triggering the electronic device to enter an image text recognition model, and outputting an image preview interface.

52, obtaining the text image collected by an image collector of the electronic device, and displaying the text image in the image preview interface.

53, obtaining the contextual information of the interactive environment during the response process of the image text recognition trigger operation.

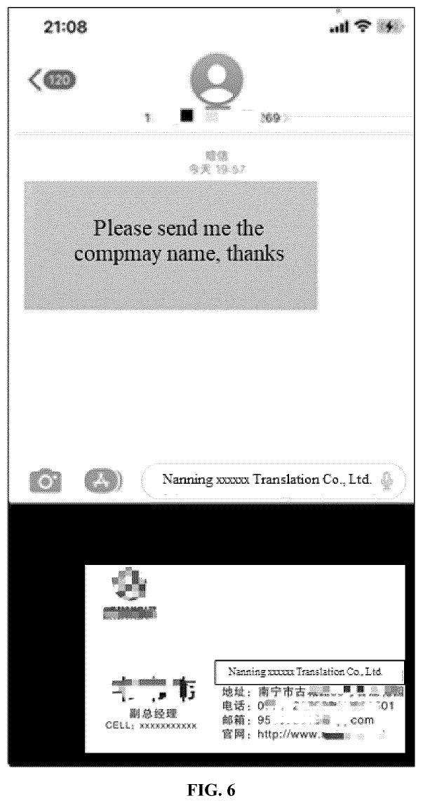

Take the interactive environment as a conversation environment as an example. FIG. 6 is a schematic diagram of a scenario of the text recognition method according to an embodiment of the present disclosure. During the conversation, if the other party wants to send the text on an object, for example, the scenario shown in FIG. 6 is the process of sending the company name of a local user, the user may select any object with the company name in the environment and trigger the image text recognition identifier on the conversation interface, initiate the camera of the electronic device, adjust the shooting direction of the camera, and collect images in the direction of the company name on the object to obtain a text image containing the company name.

Based on this, in response to the image text recognition trigger operation performed by the user, the electronic device may be triggered to enter the image text recognition mode, initiate the image collector (such as a camera) of the electronic device, and output the image preview interface to display the images collected by the camera. In some embodiments, the image preview interface may be located in part of the display area of the conversation interface, such as the lower display area of the interface as shown in FIG. 6, to display images collected by the camera in real time.

Accordingly, the user can adjust the position of the electronic device, change the relative positional relationship between the lens of the image collector and the object area containing the to-be-recognized text, and send the image collected by the image collector to the processor. After the text image is obtained, the processor can control the display on the image preview interface. However, the present disclosure is not limited to the text image output method described in this embodiment.

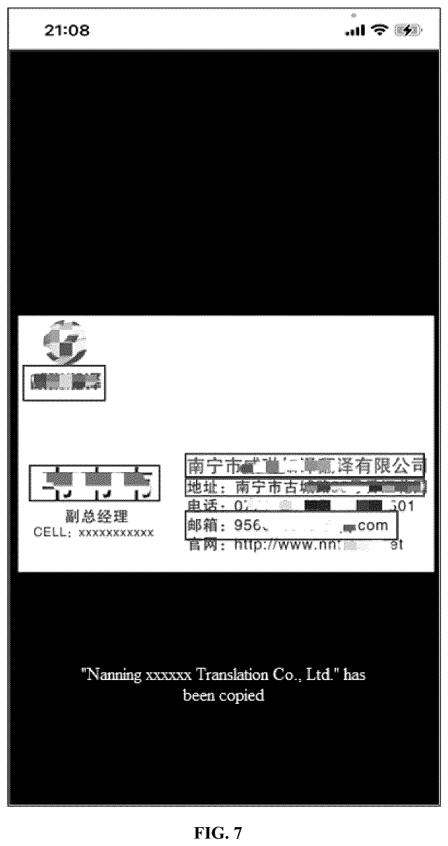

FIG. 7 is a schematic diagram of another scenario of the text recognition method according to an embodiment of the present disclosure. As shown in FIG. 7, after the electronic device enters the image text recognition mode, the electronic device can also jump to the output image preview interface from the conversation interface (that is, the operation interface in the interactive environment) to display the text images collected by the image collector in real time.

Consistent with the present disclosure, the contextual information of the current interactive environment can be obtained when the user triggers the image text recognition identifier and the electronic device responds to the image text recognition trigger operation, or during the implementation process of obtaining the text image after obtaining the image text recognition trigger operation. The present disclosure does not limit the acquisition method of the contextual information.

In some embodiments, in any interactive environment of the electronic device, the generated interactive information may be stored as historical information for subsequent query. Accordingly, when entering the image text recognition mode and there is a need to generate the text filtering condition for the to-be-recognized text, contextual information related to the current interactive environment can be obtained from the historical information stored in a storage device. For the implementation process, reference can be made to the description of the corresponding part of the contextual information, which will not be described in detail here.

54, obtaining the text filtering condition for the to-be-recognized text based on contextual information.

For the implementation process of the process at 54, reference can be made to the relevant description of the corresponding parts of the foregoing embodiments, which will not be repeated here.

55, performing text recognition on the obtained text image to obtain a plurality of texts included in the text image.

56, comparing the plurality of texts with the text filtering condition respectively, and identifying a plurality of candidate texts that meet the text filtering condition from the plurality of texts included in the text image.

57, outputting the plurality of identified candidate texts.

58, obtaining a selected to-be-recognized text in response to a selection operation on the plurality of candidate texts.

In the embodiments of the present disclosure, after comparing the plurality of texts filtered out from the text image with the text filtering condition, a plurality of texts that meet the text filtering condition may be identified. The texts that meet the text filtering condition may be determined as candidate texts, from which the user may determine the required to-be-recognized texts. Of course, a plurality of texts that meet the text filtering condition may also be determined as the to-be-recognized texts, and the to-be-recognized texts may be directly output.

For the plurality of determined candidate texts, the display state of the text image may be adjusted to highlight the plurality of candidate texts such that the user can select the required to-be-recognized text. Of course, as described above, a text filtering interface may also be output, and the plurality of determined candidate texts may be displayed on the text filtering interface for the user to select the required to-be-recognized text. Subsequently, the electronic device may respond to the selection operation on the plurality of candidate texts and obtain the selected to-be-recognized text.

Consistent with the present disclosure, after the plurality of candidate texts that may need to be input are automatically determined based on the text filtering condition, the user only needs to check the plurality of candidate texts to determine the to-be-recognized text. Compared with the text recognition method where a user needs to directly check the text content one by one from all the texts included in the text image to determine the text to-be-recognized text, in the present disclosure, the number of texts that need to be reviewed by the user is reduced and the text recognition efficiency is improved.

It should be noted that based on the text recognition result and the text filtering condition, the text image containing a to-be-recognized text that meets the text filtering condition may be determined. At this time, the to-be-recognized text may be directly output based on the method described in the foregoing embodiments.

59, outputting copy prompt information for a to-be-recognized file.

510, writing the copied to-be-recognized file into the text input area and displaying the to-be-recognized text in the text input are in response to an input trigger operation on the text input area in the interactive environment.

As described above, one of the output methods of the obtained to-be-recognized text may include directly writing the to-be-recognized text into the text input area for display. Of course, as described in this embodiment, after obtaining the to-be-recognized text included in the text image, copy prompt information for the to-be-recognized text may be output. As shown in FIG. 7, the text image display interface outputs that “Nanning xxxxxx Translation Co., Ltd.” has been copied to prompt the user to write the copied to-be-recognized text into the corresponding text input area. However, it should be noted that the copy prompt information and its output method is not limited to the example described in this embodiment.

In some embodiments, the output copy prompt information may include the to-be-recognized text. The user may further determine whether the to-be-recognized text is the required input text. If so, the to-be-recognized text can be written into to the text input area; otherwise, the input can be cancelled and a next text image can be obtained to re-recognized the required input text; or the user can be prompted to manually input the to-be-recognized text, or manually select the to-be-recognized text from each text recognized by the text image based on the method shown in FIG. 2. The implementation process will not be described in detail in the present disclosure.

Based on this, if the current display interface of the electronic device does not have a text input area in the interactive environment, the electronic device may return to the display interface where the text input area is located in the interactive environment, and perform the trigger operation on the text input area to input the copied to-be-recognized text. More specifically, in response to the input trigger operation on the text input area in the interactive environment, after determining the text input area where the to-be-recognized text needs to be input, the electronic device may write the copied to-be-recognized text into the text input area and directly display the to-be-recognized text in the text input area. Accordingly, there is no need for the user to input the to-be-recognized text word by word, which reduces the user's text input workload and improves text input efficiency.

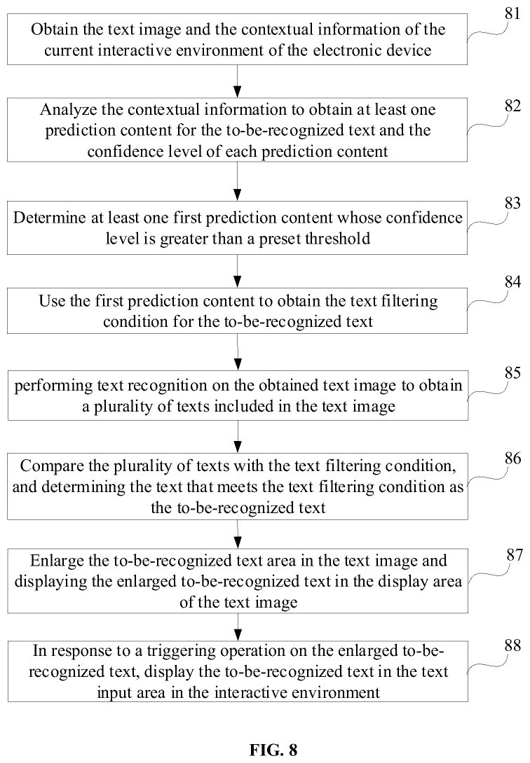

FIG. 8 is a flowchart of the text recognition method according to an embodiment of the present disclosure. This embodiment describes a refined implementation method of the text recognition method described above. The refined implementation method can still be applied to electronic devices. The method will be described in detail below.

81, obtaining the text image and the contextual information of the current interactive environment of the electronic device.

For the implementation process of the process at 81, reference can be made to the relevant description of the corresponding parts of the foregoing embodiments, which will not be repeated here.

82, analyzing the contextual information to obtain at least one prediction content for the to-be-recognized text and the confidence level of each prediction content.

In some embodiments, there may be no contextual information in the interactive environment, or the existing contextual information may be inaccurate, making it difficult to accurately predict the text content that needs to be input later. That is, the contextual information containing individual words may interfere with the prediction of the to-be-recognized text. Therefore, in the process of generating the text filtering condition based on the contextual information, the confidence level of each prediction content of the to-be-recognized text (such as the keyword or their synonyms in the contextual information) can be obtained. The confidence level indicates the probability that the corresponding prediction content can indicate the current to-be-recognized text. Generally, the greater the confidence level of the prediction content, the higher the prediction accuracy of the current to-be-recognized text. The present disclosure does not limit the method of obtaining the prediction content and its confidence level.

In some embodiments, a text recognition prediction model for predicting the prediction content included or represented by the contextual information may be pre-trained and stored. Accordingly, when there is a need to obtain the text filtering condition for the to-be-recognized text, the text recognition prediction model can be obtained such that the contextual information in the current interactive environment can be processed based on the text recognition prediction model to obtain at least one prediction content for the to-be-recognized text, as well as the confidence of each prediction content, such as the prediction probability or prediction score of each prediction content. The implementation process will not be described in detail in the present disclosure.

It should be noted that when the interactive environment in which the electronic device is located is an information entry environment or a product search environment, the contextual information may include the prompt information of the input box/search box, and may also include other content included in the information input interface, or other content included in the product search interface. Accordingly, in the process of generating the text filtering condition, contextual information can be analyzed to obtain a plurality of prediction contents in multiple dimensions. For the subsequent implementation process, reference can be made to the description of the processes below. The present disclosure does not describe the text recognition methods in various interactive environments.

83, determining at least one first prediction content whose confidence level is greater than a preset threshold.

84, using the first prediction content to obtain the text filtering condition for the to-be-recognized text.

Continuing with the above analysis, the confidence threshold that can accurately predict the prediction content of the to-be-recognized text may be determined in advance, which can be recorded as the preset threshold. Accordingly, the confidence of each prediction content can be compared with the preset threshold, and the first prediction content whose confidence is greater than the preset threshold can be determined, thereby using the at least one first prediction content to generate the text filtering condition for the to-be-recognized text. For the implementation process, reference can be made to the description of the corresponding parts of the foregoing embodiments.

85, performing text recognition on the obtained text image to obtain a plurality of texts included in the text image.

86, comparing the plurality of texts with the text filtering condition, and determining the text that meets the text filtering condition as the to-be-recognized text.

For the implementation process of the processes at 85 and 86, reference can be made to the relevant description of the corresponding parts of the foregoing embodiments, which will not be repeated here.

It should be noted that after comparing the confidence of each prediction content with the preset threshold, it may be determined that the confidence of each prediction content is not greater than the preset threshold. That is, it is determined that the confidence level of at least one prediction content obtained is less than or equal to the preset threshold. Subsequently, text recognition may be performed directly on the text image without generating the text filtering condition to obtain the corresponding text recognition result, that is, determining the text included in the text image. Afterwards, the to-be-recognized text may be obtained based on the text recognition result. For example, the required to-be-recognized text may be determined in response to the selection operation of each to-be-recognized text in the text image.

Of course, with the text recognition method shown in FIG. 1, when it is determined that the confidence of at least one prediction content included is less than or equal to the preset threshold, the text at the center of the text image may be recognized, and the display state of the text at the center of the text image may be adjusted such that the user can determine whether the text is the required to-be-recognized text. If not, parameters such as the shoot position and/or shooting angle of the electronic device may be adjusted such that the required to-be-recognized text is in the center of the preview text image, then text recognition may be re-performed based on the method described above to obtain the required to-be-recognized text.

It can be seen that even if the prediction of the to-be-recognized text by the contextual information is inaccurate, the text image may still be recognized based on the above method to obtain the required to-be-recognized text, and the user does not need to manually enter each word of the to-be-recognized text, thereby ensuring the efficiency of text input.

87, enlarging the to-be-recognized text area in the text image and displaying the enlarged to-be-recognized text in the display area of the text image.

88, in response to a triggering operation on the enlarged to-be-recognized text, displaying the to-be-recognized text in the text input area in the interactive environment.

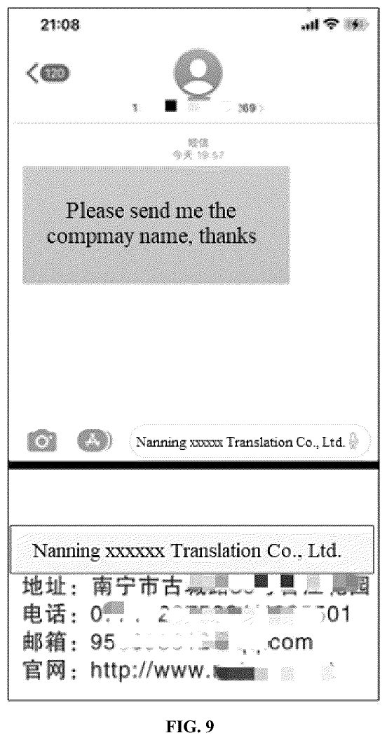

Based on the method described above, after the to-be-recognized text is obtained from the text image, the output method described in the foregoing embodiments can be used. In order for the user to conveniently check the content of the to-be-recognized text, the to-be-recognized text area of the text image may also be enlarged. FIG. 9 is a schematic diagram of a scenario for outputting to-be-recognized text in the text recognition method according to an embodiment of the present disclosure. As shown in FIG. 9, the to-be-recognized text can be displayed in the display area of the text image. However, the present disclosure is not limited thereto. After the user determines that the to-be-recognized text is the text content that needs to be input, the to-be-recognized text can be triggered to input the to-be-recognized text into the text input area in the current interactive environment for display.

In some embodiments, in the process of enlarging and displaying the determined to-be-recognized text, the obtained to-be-recognized text may also be directly written into the text input area in the interactive environment, and the to-be-recognized text may be displayed in the text input area. Of course, if the user checks the enlarged to-be-recognized text and determined that the to-be-recognized text is incorrect, the user may also dele the input to-be-recognized text, re-obtain the text image based on the method described above, and perform the text recognition on the text image to obtain the required to-be-recognized text.

In some embodiments, after enlarging the obtained to-be-recognized text, operations such as performing a trigger operation on the enlarged to-be-recognized text, controlling the to-be-recognized text to enter an editing state to responds to the editing operation of the to-be-recognized text (e.g., selecting part of the to-be-recognized text, modifying the to-be-recognized text, etc.), obtaining the edited input text, writing the input text into the text input area in the interactive environment for display may also be performed. The present disclosure does not limit the editing method of the to-be-recognized text, which can be set based on actual needs.

It should be noted that after the to-be-recognized text is determined in the text image, a text recognition window may also be output in the display area of the text image. The to-be-recognized text may be displayed in the text recognition window and wait for the to-be-output recognized text. The present disclosure does not limit the output method of the to-be-recognized text, which can be set based on actual needs.

In addition, each step of the foregoing method embodiments can be completed by an integrated logic circuit in the form of hardware or instructions in the form of software in the processor of the electronic device. The processor is configured to perform the text recognition method described in the foregoing method embodiments, or a combination of hardware and software modules in the processor can be configured to perform each text recognition method. The software module can be stored in the memory of the electronic device. The memory may be a random-access memory, a flash memory, a read-only memory, a programmable read-only memory, an electrically erasable programmable memory, a register, etc. The processor reads the instructions stored in the memory, and combines the hardware of the electronic device to complete the text recognition method provided in the foregoing embodiments.

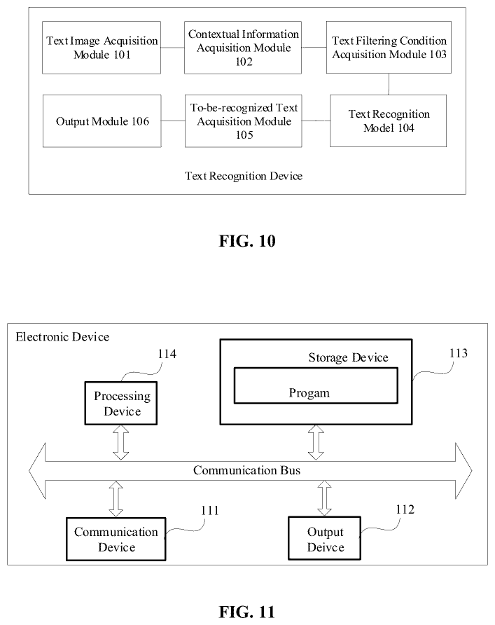

FIG. 10 is a schematic structural diagram of a text recognition device according to an embodiment of the present disclosure. As shown in FIG. 10, the text recognition device includes a text image acquisition module 101, a contextual information acquisition module 102, a text filtering condition acquisition module 103, a text recognition model 104, a to-be-recognized text acquisition module 105, and an output module 106.

In some embodiments, the text image acquisition module 101 may be configured to obtain a text image, the text image being obtained by collecting images of the to-be-recognized text.

In some embodiments, the contextual information acquisition module 102 may be configured to obtain the contextual information of the interactive environment in which the electronic device is currently located.

In some embodiments, the text filtering condition acquisition module 103 may be configured to obtain the text filtering condition for the to-be-recognized text based on the contextual information.

In some embodiments, the text recognition model 104 may be configured to perform text recognition on the text image and obtain the corresponding text recognition result.

In some embodiments, the to-be-recognized text acquisition module 105 may be configured to perform text recognition on the text image based on the text filtering condition and the text recognition result to obtain the to-be-recognized text included in the text image.

In some embodiments, the output module 106 may be configured to output the to-be-recognized text.

In some embodiments, the output module 106 may include one or more of an enlargement display unit, a first display unit, a second display unit, and an adjustment unit. The enlargement display unit may be configured to enlarge the to-be-recognized text area in the text image, and display the enlarged to-be-recognized text in the display area of the text image. The first display unit may be configured to output a text recognition window in the display area of the text image, and display the to-be-recognized text in the text recognition window. The second display unit may be configured to the to-be-recognized text in the text input area in the interactive environment. The adjustment unit may be configured to adjust the display state of the to-be-recognized text in the text image.

In some embodiments, the second display unit may include a third display unit, a copy prompt information output unit, or a fourth display unit. The third display unit may be configured to write the obtained to-be-recognized text into the text input area in the interactive environment, and display the to-be-recognized text in the text input area. The copy prompt information output unit may be configured to output copy prompt information for the to-be-recognized file. The fourth display unit may be configured to respond to an input trigger operation on the text input area in the interactive environment, write the copied to-be-recognized file into the text input area, and display the to-be-recognized text in the text input area.

In some embodiments, the to-be-recognized text acquisition module 105 may include a candidate text determination unit, a candidate text output unit, and a first acquisition unit. The candidate text determination unit may be configured to compare a plurality of texts included in the text recognition result with the text filtering condition, and determine a plurality of candidate texts that meet the text filtering condition included in the text image. The candidate text output unit may be configured to output the plurality of candidate texts. The first acquisition unit may be configured to obtain the selected to-be-recognized text in response to a selection operation on the plurality of candidate texts.

In some embodiments, the text filtering condition acquisition module 103 may include a prediction unit, a first prediction content determination unit, and a second acquisition unit. The prediction unit may be configured to analyze the contextual information to obtain at least one prediction content for the to-be-recognized text, and a confidence level of each prediction content. The first prediction content determination unit may be configured to determine the first prediction content in the at least one prediction content in which the confidence level is greater than a preset threshold. The second acquisition unit may be configured to use the first prediction content to obtain the text filtering condition for the to-be-recognized text.

In some embodiments, the prediction unit may include a text recognition prediction model acquisition unit and a first processing unit. The text recognition prediction model acquisition unit may be configured to obtain the text recognition prediction model. The first processing unit may be configured to process the contextual information based on the text recognition prediction model to obtain at least one prediction content for the to-be-recognized text, and a confidence level of each prediction content.

In some embodiments, the text filtering condition acquisition module 103 may include a keyword extraction unit and a third acquisition unit. The keyword extraction unit may be configured to extract keywords from the contextual information to obtain at least one keyword in the interactive environment. The third acquisition unit may be configured to use the at least one keyword to obtain the text filtering condition for the to-be-recognized text.

Based on the text recognition device described in the foregoing embodiments, the device may also include a text recognition result acquisition module and a first acquisition module. The text recognition result acquisition module may be configured to determine that the confidence level of the at least one prediction content is less than or equal to the preset threshold, perform text recognition on the text image, and obtain the corresponding text recognition result. The first acquisition module may be configured to obtain the to-be-recognized text based on the text recognition result.

It should be noted that the various modules, units, etc. in the above device embodiments can be stored in the memory of the electronic device as program modules, and the processor of the electronic device can execute the program modules stored in the memory to implement the corresponding functions. For the function implemented by each program module and its combination, as well as the technical effects achieved, reference can be made to the description of the corresponding parts of the foregoing method embodiments, which will not be repeated here.

The present disclosure also provides a computer-readable storage medium having computer-readable instructions stored thereon. The computer-readable instructions can be called and loaded by the processor to implement various steps of the text recognition method described in the foregoing embodiments. For the implementation process, reference can be made to the description of the foregoing method embodiments, which will not be repeated here.

FIG. 11 is a hardware structural diagram of an electronic device suitable for the text recognition method according to an embodiment of the present disclosure. The electronic device includes a communication device 111, an output device 112, a storage device 113, and a processing device 114.

The communication device 111, the output device 112, the storage device 113, and the processing device 114 may be connected through a bus, but the connection is not limited to the connection method shown in FIG. 11. In addition, the connection method of the communication device 111, the output device 112, the storage device 113, and the processing device 114 with other components of the electronic device will not be described in detail in the present disclosure. In some embodiments, the bus may include an address bus, a data bus, a control bus, and the like.

The communication device 111 may include a communication module capable of realizing data interaction using a wireless communication network such as a WIFI module, a fifth-generation mobile communication network/sixth-generation mobile communication network (5G/6G) module, a GPRS module, a radio frequency module, a Bluetooth module, etc. such that the electronic device can communicate with other electronic devices through the communication module to meet actual communication needs. Of course, the communication device 111 may also include a communication interface that implements data exchange between internal components of the electronic device, such as a USB interface, a serial/parallel port, various multimedia interfaces and other data interfaces to meet the transmission needs of content such as text mages, to-be-recognized text, command signals, etc. The present disclosure does not limit the specific content included in the communication device 111.

The output device 112 may include, but is not limited to, a display. The display may be used to output text images, interactive interfaces in an interactive environment, etc., and may be determined based on the data output requirements. The present disclosure does not limit the type of output device 112 and its working process.

The storage device 113 may be used to store programs that implement the text recognition method provided in the present disclosure. Processing device 114 may be used to load and execute the programs stored in the storage device 113 to implement the text recognition method provided in the present disclosure.

In some embodiments, the storage device 113 may be a non-volatile memory such as a hard disk drive (HDD) or a solid-state drive (SSD), or a volatile memory such as a random-access memory (RAM), etc. As analyzed above, storage device 113 may be any available storage medium that can be accessed by the processing device and/or the electronic device. It should be understood that the storage device 113 of the present disclosure can also be a circuit or any other device capable of realizing the storage function, used to store program instructions and/or data. The present disclosure does not limit the type of storage device 113 and its physical connection relationship with other devices described above, which can be set based on actual needs.

In some embodiments, processing device 114 may also include one or more processors to execute the text recognition method provided in the present disclosure. The one or more processors may include, but are not limited to, digital signal processors (DSPs), digital signal processing devices (DSPDs), application-specific integrated circuits (ASICs), field-programmable gate arrays (FPGAs), programmable logic devices (PLDs), central processing units (CPUs), processing circuits or other suitable hardware, firmware, and/or a combination of hardware and software. The present disclosure does not limit the composition of the processing device 114 of the electronic device.

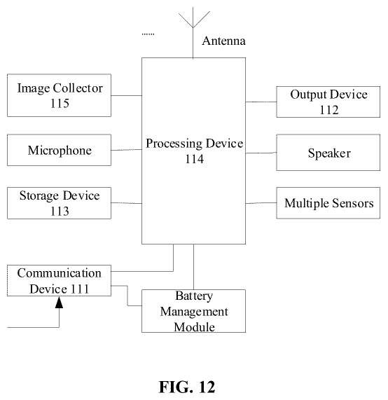

In some embodiments, in order to obtain text images, as shown in FIG. 12, the electronic device may also include an image collector 115 such as a camera for collecting text images. Of course, the electronic device may also be connected to other independent image acquisition devices to obtain text images collected by the image acquisition device and execute the text recognition method provided in the present disclosure. In some embodiments, the text images may also be transmitted from other devices, and the text images containing the to-be-recognized text can be read from the storage device 113 of the electronic device. The present disclosure does not limit the acquisition of the text images, which can be set based on actual needs.

According to the specifications and claims in the present application, unless otherwise specified in the context, articles such as “a,” “an,” and/or “the” do not necessarily indicate singular forms, and also include plural forms. Generally, expressions such as “include” and “comprise” are only used to indicate specified steps or elements. However, listings of these steps and elements are not exclusive, and methods or devices may also include other steps or elements.

In the description of the present disclosure, unless otherwise specified, “I” represents an “or” relationship between a preceding object and a following object. For example, “A/B” may represent A or B. The term “and/or” used in this application merely describes an association relationship between associated objects, and represents three possible relationships. For example, “A and/or B” may represent three scenarios: A alone, both A and B, and B alone, where A and B may be singular or plural. In addition, in the description of this application, “a plurality of” means two or more than two.

Further, in the present disclosure, relational terms such as first, second, and the like, may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

The embodiments in this specification are described in a progressive manner, each embodiment emphasizes a difference from the other embodiments, and the identical or similar parts between the embodiments may be made reference to each other. Since the apparatus and electronic device disclosed in the embodiments are corresponding to the methods disclosed in the embodiments, the descriptions of the apparatus and electronic device are simple and relevant parts may be made reference to the description of the methods.

The description of the disclosed embodiments is provided to illustrate the present application to those skilled in the art. Various modifications to these embodiments will be readily apparent to those skilled in the art, and the generic principles defined herein may be applied to other embodiments without departing from the spirit or scope of the application. Thus, the present application is not intended to be limited to the embodiments shown herein but is to be accorded the widest scope consistent with the principles and novel features disclosed herein.

What is claimed is:

1. A text recognition method comprising:
obtaining a text image and contextual information of an interactive environment in which the electronic device is currently located, the text image being obtained by collecting images of a to-be-recognized text;
obtaining a text filtering condition for the to-be-recognized text based on the contextual information;
performing text recognition on the text image to obtain a corresponding text recognition result;
obtaining the to-be-recognized text included in the text image based on the text filtering condition and the text recognition result; and
outputting the to-be-recognized text.

2. The method of claim 1, wherein outputting the to-be-recognized text includes at least one of:
enlarging a to-be-recognized text area and displaying the enlarged to-be-recognized text in a display area of the text image;
outputting a text recognition window in the display area of the text image and displaying the to-be-recognized text in the text recognition window;
displaying the to-be-recognized text in a text input area in the interactive environment; and
adjusting a display state of the to-be-recognized text in the text image.

3. The method of claim 2, wherein displaying the to-be-recognized text in the text input area in the interactive environment includes:
writing the obtained to-be-recognized text into the text input area in the interactive environment and displaying a to-be-recognized file in the text input area; or,
outputting copy prompt information for a to-be-recognized file;
in response to an input triggering operation on the text input area in the interactive environment, writing the copied to-be-recognized file into the text input area, and displaying the to-be-recognized text in the text input area.

4. The method of claim 1, wherein obtaining the to-be-recognized text included in the text image based on the text filtering condition and the contextual information includes:
comparing a plurality of texts included in the text recognition result with the text filtering condition respectively, and determining a plurality of candidate texts included in the text image that meet the text filtering condition;
outputting the plurality of candidate texts; and
in response to a selection operation on the plurality of candidate texts, obtaining a selected to-be-recognized text.

5. The method of claim 1, wherein obtaining the text filtering condition for the to-be-recognized text includes:
analyzing the contextual information to obtain at least one prediction content for the to-be-recognized text, and a confidence level for each prediction content;
determining a first prediction content in the at least one prediction content whose confidence level is greater than a preset threshold; and
using the first prediction content to obtain the text filtering condition for the to-be-recognized text.

6. The method of claim 5, wherein analyzing the contextual information to obtain at least one prediction content for the to-be-recognized text, and the confidence level for each prediction content includes:
obtaining a text recognition prediction model; and
processing the contextual information to obtain the at least one prediction content for the to-be-recognized text, and the confidence level of each prediction content based on the text recognition prediction model.

7. The method of claim 1, wherein obtaining the text filtering condition for the to-be-recognized text includes:
extracting keywords from the contextual information to obtain at least one keyword in the interactive environment; and
using the at least one keyword to obtain the text filtering condition for the to-be-recognized text.

8. The method of claim 5 further comprising:
determining that the confidence level of the at least one prediction content is less than or equal to the preset threshold, and performing text recognition on the text image to obtain the corresponding text recognition result; and
obtaining the to-be-recognized text based on the text recognition result.

9. A text recognition device comprising:
a text image acquisition module, the text image acquisition module being configured to obtain a text image, the text image being obtained by collecting images of a to-be-recognized text;
a contextual information acquisition module, the contextual information acquisition module being configured to obtain the contextual information of a current interactive environment of an electronic device;
a text filtering condition acquisition module, the text filtering condition acquisition module being configured to obtain a text filtering condition for the to-be-recognized text based on the contextual information;
a text recognition model, the text recognition model being used to perform text recognition on the text image to obtain a corresponding text recognition result;
a to-be-recognized text acquisition module, the to-be-recognized text acquisition module being configured to perform text recognition on the text image based on the text filtering condition and the text recognition result to obtain the to-be-recognized text included in the text image; and
an output module, the output module being configured to output the to-be-recognized text.

10. An electronic device comprising:
a communication device;
an output device;
a storage device to store a program for implementing a text recognition method; and
a processing device, the processing device being configured to load and execute the program stored in the storage device to implement the text recognition method, the text recognition method includes:
obtaining a text image and contextual information of an interactive environment in which the electronic device is currently located, the text image being obtained by collecting images of a to-be-recognized text;
obtaining a text filtering condition for the to-be-recognized text based on the contextual information;
performing text recognition on the text image to obtain a corresponding text recognition result;
obtaining the to-be-recognized text included in the text image based on the text filtering condition and the text recognition result; and
outputting the to-be-recognized text.

11. The electronic device of claim 10, wherein outputting the to-be-recognized text includes at least one of:
enlarging a to-be-recognized text area and displaying the enlarged to-be-recognized text in a display area of the text image;
outputting a text recognition window in the display area of the text image and displaying the to-be-recognized text in the text recognition window;
displaying the to-be-recognized text in a text input area in the interactive environment; and
adjusting a display state of the to-be-recognized text in the text image.

12. The electronic device of claim 11, wherein displaying the to-be-recognized text in the text input area in the interactive environment includes:
writing the obtained to-be-recognized text into the text input area in the interactive environment and displaying a to-be-recognized file in the text input area; or,
outputting copy prompt information for a to-be-recognized file;
in response to an input triggering operation on the text input area in the interactive environment, writing the copied to-be-recognized file into the text input area, and displaying the to-be-recognized text in the text input area.

13. The electronic device of claim 10, wherein obtaining the to-be-recognized text included in the text image based on the text filtering condition and the contextual information includes:
comparing a plurality of texts included in the text recognition result with the text filtering condition respectively, and determining a plurality of candidate texts included in the text image that meet the text filtering condition;
outputting the plurality of candidate texts; and
in response to a selection operation on the plurality of candidate texts, obtaining a selected to-be-recognized text.

14. The electronic device of claim 10, wherein obtaining the text filtering condition for the to-be-recognized text includes:
analyzing the contextual information to obtain at least one prediction content for the to-be-recognized text, and a confidence level for each prediction content;
determining a first prediction content in the at least one prediction content whose confidence level is greater than a preset threshold; and
using the first prediction content to obtain the text filtering condition for the to-be-recognized text.

15. The electronic device of claim 14, wherein analyzing the contextual information to obtain at least one prediction content for the to-be-recognized text, and the confidence level for each prediction content includes:
obtaining a text recognition prediction model; and
processing the contextual information to obtain the at least one prediction content for the to-be-recognized text, and the confidence level of each prediction content based on the text recognition prediction model.

16. The electronic device of claim 10, wherein obtaining the text filtering condition for the to-be-recognized text includes:
extracting keywords from the contextual information to obtain at least one keyword in the interactive environment; and
using the at least one keyword to obtain the text filtering condition for the to-be-recognized text.

17. The electronic device of claim 14, wherein the text recognition further comprising:
determining that the confidence level of the at least one prediction content is less than or equal to the preset threshold, and performing text recognition on the text image to obtain the corresponding text recognition result; and
obtaining the to-be-recognized text based on the text recognition result.
